(19) United States
(12) Patent Application Publication
(10) Pub. No.: US 2010/0141553 A1
(43) Pub. Date: Jun. 10, 2010

(54) METHOD FOR OPERATING A DISPLAY SYSTEM

(75) Inventors: Rene Berhorst, Hovelhof (DE); Michael Adenau, Wurzburg (DE)

Correspondence Address: SCHWEGMAN, LUNDBERG & WOESSNER, P.A., P.O. BOX 2938, MINNEAPOLIS, MN, 55402, US

(73) Assignee: MA LIGHTING TECHNOLOGY GmbH, Waldbuttelbrunn (DE)

(21) Appl. No.: 12/328,147

(22) Filed: Dec. 4, 2008

(51) Int. Cl. G09G 5/00

(52) U.S. Cl. 345/3.1

(57) ABSTRACT

The invention relates to a method for operating a display system comprising at least one central control device, in particular a lighting control console, and comprising a plurality of display media, wherein each display medium comprises a local control device and a display device for displaying partial image surfaces, and wherein the central control device can exchange data with the local control devices via data interfaces, comprising the following method steps:
a) definition of a virtual display surface on which a predetermined total image can be displayed and a virtual observer position from where the display surface is observed, wherein the relative arrangement between the virtual display surface, the virtual observer position and the positioning of the individual display device is known;
b) computing the partial image surfaces of the total image, which must be displayed on the display devices of the different display media as a function of the relative arrangement between the virtual display surface, the virtual observer position and the positioning of the individual display device for the positionally accurate display of the total image;
c) display of the computed partial image surfaces on the display devices of the different display media.

The invention relates to a method for operating a display system according to the teaching of the preamble of claim 1.

Generic display systems are used, for example, but by no means exclusively, in the context of television shows or concerts for the purpose of generating corresponding show effects. The display systems thereby comprise a plurality of display media, which in turn consist in each case of a local control device, for example a media server, and a display device, for example a digital projector comprising a related projection surface. The different display media are thereby connected to a central control device, for example a lighting control console, via data lines and data interfaces. The director of the show can then carry out corresponding inputs at the central control device for the purpose of displaying certain images on the different display devices. Partial image surfaces can thus in each case be projected or displayed on the display devices, which show film clips or show sequences.

It is a disadvantage of the known display systems that the partial image surfaces displayed by the individual display devices do not exhibit an inner connection. This means, in other words, that the partial images displayed by the individual display devices do not have an inner connection and that they are displayed in each case by themselves. The maximum size of the images which can be displayed by means of the display system is thus a function of the respectively largest display device of the different display media.

Based on this state of the art, it is thus the object of the present invention to propose a new method for operating a display system, by means of which partial image surfaces, which can be displayed by the individual display devices, can be combined to form larger display units. This object is solved by means of a method according to the teaching of claim 1.

Advantageous embodiments of the invention are the object of the subclaims.

The display method according to the invention is initially based on the basic idea that a virtual display surface is defined on which a predetermined total image can be displayed. The virtual display surface is thereby solely a mathematically defined operand, which defines the position and form of the display in the two-dimensional or three-dimensional space. The virtual display surface can thereby be greater or smaller than the dimensions of the greatest individual display device. Furthermore, a virtual observer position, from where the display surface is observed, is predefined mathematically. Finally, a mathematical model in which the relative arrangement between the virtual display surface, the virtual observer position and the actual positioning of the individual display devices is known, is created in such a manner.

Based on this mathematical model, partial image surfaces of the predetermined total image are computed subsequently. These partial image surfaces must be displayed on the display devices of the different display media as a function of the relative arrangement between the virtual display surface, the virtual observer position and the positioning of the individual display devices for the positionally accurate display of the total image. This means, in other words, that the partial image surfaces that must be displayed on the individual display devices for a positionally accurate and distortion-free display of the total image are selected by means of mathematical operations from the predetermined total image, which is also a variable solely predetermined by data. The result of this operation is a display of partial image surfaces on the display devices of the different display media, which would result similarly if the total image were projected on the individual display devices by means of a large projector. The individual partial image surfaces on the display devices thus exhibit an inner connection, which corresponds to the inner connection between different sections from the total image. It goes without saying that display-free gaps can appear between the individual partial image surfaces, provided that the display devices of the different display media do not completely cover the virtual total display surface.

In the last step, the virtually computed partial image surfaces are then displayed on the display devices of the different display media.

There are different possibilities for the design of the display devices in the different display media. According to a first alternative, a projection device serves the purpose of displaying the partial images on at least one display device. The projection device in turn thereby consists of a projector and a projection surface.

A display device by means of which images can be actively displayed on a partial image surface can also be used as an alternative to a projection device. In particular screens or LED panels are possible as such active display devices.

In the simplest method alternative, the virtual display surface for displaying the total image has a planar design and the partial image surfaces of the individual display devices are also located in this plane. As a result, the total image is then only divided onto the individual partial image surfaces, wherein gaps can result between the individual partial image surfaces according to the arrangement of the individual display devices. An arrangement of the partial image surfaces of the individual display devices in the virtual display surface, however, is by no means absolutely necessary. It thus goes without saying that it is possible that the partial image surfaces are located outside of the virtual display surface and that they also do not have a planar design. Depending on the position of the partial image surfaces and depending on the design thereof, conversion operations must then be carried out, for example by means of transformation matrix operations, for the purpose of converting the partial image surfaces which are to be displayed in such a manner that the result thereof provides a distortion-free display of the total image.

According to a further method alternative, it is thereby in particular also possible that the partial image surfaces of the individual display devices have a convex or a concave design. Even such uneven partial image surfaces can be illuminated by means of corresponding conversion operations in such a manner that a distortion-free display of the respective section from the total image is made possible.

The method according to the invention also provides for the possibility that at least one partial image surface of a display device is moved dynamically. The section from the predetermined total image, which is in each case assigned to the position, is then computed and displayed, in each case in a position-dependent manner, that is, based on the position, rotation and/or the dynamically changeable form of the partial image surface. A conversion as a function of the trajectory of the partial image surface is carried out for the purpose of a positionally accurate display of the section from the predetermined total image.

According to a further method alternative, the resolution capacity of the different display devices can also be considered. Display devices comprising a very high resolution, for example image projectors, and comprising a relatively low resolution, for example LED panels, are known. If display devices comprising a different resolution capacity are used for displaying a total image, the respective resolution capacities must be considered when converting the respective partial image surfaces which are to be displayed, so as to obtain a distortion-free total image.

To reduce the data which are to be transported along the data lines and via the data interface to a minimum, it is particularly advantageous if the respective total image which is to be displayed is locally stored on all local control devices. This makes it possible for all of the local control devices to locally compute the section which is to be displayed in each case on their display devices and to display the corresponding partial image surface. To attain the desired inner connection of the different partial image surfaces for the display of the total image, the display of the partial image surfaces must thereby be synchronized chronologically when they are not still images, which are to be displayed permanently.

The display system according to the invention is not only capable of displaying unmoved total images, but it goes without saying that it can also display chronologically arranged image sequences, in particular film sections.

1. A method for operating a display system comprising at least one central control device, in particular a lighting control console, and comprising a plurality of display media, wherein each display medium comprises a local control device and a display device for displaying partial image surfaces, and wherein the central control device can exchange data with the local control devices via data interfaces, comprising the following method steps:
a) definition of a virtual display surface on which a predetermined total image can be displayed and a virtual observer position from where the display surface is observed, wherein the relative arrangement between the virtual display surface, the virtual observer position and the positioning of the individual display device is known;
b) computing the partial image surfaces of the total image, which must be displayed on the display devices of the different display media as a function of the relative arrangement between the virtual display surface, the virtual observer position and the positioning of the individual display device for the positionally accurate display of the total image;
c) display of the computed partial image surfaces on the display devices of the different display media.

2. The method according to claim 1,
characterized in that
a projection device is used as display device of at least one display medium, by means of which projection device an image can be projected onto a projection surface which forms the partial image surface.

3. The method according to claim 1 or 2,
characterized in that
a display device is used as display device of at least one display medium, by means of which display device an image can be actively displayed on a display surface which forms the partial image surface, in particular that the display device is embodied in the manner of a screen or LED panel.

4. The method according to one of claims 1 to 3,
characterized in that
the virtual display surface on which the predetermined total image can be displayed has a planar design, wherein at least one partial image surface of a display device of the different display media, which in particular has a planar design, is not arranged in the virtual display surface and wherein a conversion is carried out as a function of the relative arrangement between the planar virtual display surface and the planar partial image surface for the purpose of displaying the partial image surface in a distortion-free manner.

5. The method according to one of claims 1 to 4,
characterized in that
the virtual display surface on which the predetermined total image can be displayed has a planar design, wherein at least one partial image surface of a display device of the different display media has a convexly or concavely curved design, and wherein a conversion is carried out as a function of the curved design of the partial image surface for the purpose of displaying the partial image surface in a distortion-free manner.

6. The method according to one of claims 1 to 5,
characterized in that
at least one partial image surface of a display device is moved dynamically, wherein a conversion is carried out as a function of the trajectory of the partial image surface for the purpose of a positionally accurate display of the section from the predetermined total image, which is assigned in each case to the position.

7. The method according to one of claims 1 to 6,
characterized in that
the resolution capacity of the display device of the different display media is known, wherein a conversion is carried out as a function of the resolution capacity of the display device for the purpose of a distortion-free display of the partial image surfaces.

8. The method according to one of claims 1 to 7,
characterized in that
the total image is stored on all local control devices, wherein the individual local control devices locally compute the partial image surface which is to be displayed on the assigned display device, and wherein the display of the partial image surfaces on the different display devices takes place in a chronologically synchronized manner.

9. The method according to one of claims 1 to 8,
characterized in that
the total image which is to be displayed changes chronologically and forms a chronologically controlled image sequence, in particular a film section.
